(19) United States
(12) Patent Application Publication
(10) Pub. No.: US 2013/0321905 A1
(43) Pub. Date: Dec. 5, 2013

(54) Multilayer Structure

(71) Applicant: Agency for Science, Technology and Research, Singapore (SG)

(72) Inventors: Shijie WANG, Singapore (SG); Lai Mun Nancy WONG, Singapore (SG)

(73) Assignee: Agency for Science, Technology and Research, Singapore (SG)

(21) Appl. No.: 13/893,024

(22) Filed: May 13, 2013

(30) Foreign Application Priority Data
May 11, 2012 (SG) SG201203481-5

(51) Int. Cl. G02B 5/20

(52) U.S. Cl. CPC G02B 5/208
USPC 359/360; 427/58; 359/359

(57) ABSTRACT

A multilayer structure having a plurality of layers, with each layer being optically transparent over a selective wavelength range and being electrically conducting. The multilayer structure includes a top oxide layer having an exposed top surface that provides an outer surface of the multilayer structure and an inner surface that is opposite to the exposed top surface; a bottom oxide layer having an exposed bottom surface that provides an outer surface of the multilayer structure, which is opposite to the exposed top surface, and an inner surface that is opposite to the exposed bottom surface; a first control layer provided on the inner surface of the top oxide layer; and a second control layer provided on the inner surface of the bottom oxide layer, the first and the second control layers calibrated to have the multilayer structure attenuate light over two different wavelength ranges.

This application claims the benefit of priority of Singapore Patent Application 201203481-5, filed May 11, 2012, the contents of which are hereby incorporated by reference in its entirety for all purposes.

### FIELD OF INVENTION

The invention relates generally to a multilayer structure.

### BACKGROUND

Multilayer structures used to coat, for example, windows of buildings or automobiles should ideally be optically transparent over a wavelength range of 400 to 700 nm, while rejecting light in the near-infrared (NIR) spectrum (also called IR-A with wavelength range of 700 nm-1400 nm) and the short-wavelength infrared range (SWIR, also called IR-B with wavelength range of 1.4-3 μm).

While available multilayer structures that use, for example, ITO (indium tin oxide), reject NIR and SWIR light, they significantly reduce the transmission of light in the 400 to 700 nm range. In addition, such multilayer structures are increasingly being used in photovoltaic and optoelectronic applications, so these multilayer structures also are preferred to be electrically conductive.

Having multilayer structures to be both optically transparent and electrically conductive poses several difficulties. For the multilayer structures that use ITO, they have to be fabricated under high temperature to achieve good optical transparency and electrical conductivity. Unfortunately, such high temperature fabrication limits the use of such multilayer structures in temperature sensitive devices. Further, it would also be advantageous to improve upon the NIR and SWIR wavelength rejection that multilayer structures using ITO provide.

A need therefore exists to provide a multilayer structure that addresses the above difficulties.

### SUMMARY

According to a first aspect of the invention, there is provided a multilayer structure having a plurality of layers, with each layer being optically transparent over a selective wavelength range and being electrically conducting, the multilayer structure comprising a top oxide layer having an exposed top surface that provides an outer surface of the multilayer structure and an inner surface that is opposite to the exposed top surface; a bottom oxide layer having an exposed bottom surface that provides an outer surface of the multilayer structure, which is opposite to the exposed top surface, and an inner surface that is opposite to the exposed bottom surface; a first control layer provided on the inner surface of the top oxide layer; and a second control layer provided on the inner surface of the bottom oxide layer, the first and the second control layers calibrated to have the multilayer structure attenuate light over a first wavelength range and over a second wavelength range, the light of the first wavelength range being different from the light of the second wavelength range.

According to a second aspect of the invention, there is provided a compound structure comprising: a substrate; a multilayer structure provided on a surface of the substrate, the multilayer structure having a plurality of layers, with each layer being optically transparent over a selective wavelength range and being electrically conducting, the multilayer structure comprising a top oxide layer having an exposed top surface that provides an outer surface of the multilayer structure and an inner surface that is opposite to the exposed top surface; a bottom oxide layer having an exposed bottom surface that provides an outer surface of the multilayer structure, which is opposite to the exposed top surface, and an inner surface that is opposite to the exposed bottom surface; a first control layer provided on the inner surface of the top oxide layer; and a second control layer provided on the inner surface of the bottom oxide layer, the first and the second control layers calibrated to have the multilayer structure attenuate light over a first wavelength range and attenuate light over a second wavelength range, the light of the first wavelength range being different from the light of the second wavelength range; and at least one oxide film calibrated to attenuate light over a third wavelength range, the light of the third wavelength range being different from the light of the first and the second wavelength ranges.

According to a third aspect of the invention, there is provided a method of forming a multilayer structure having a plurality of layers, with each being optically transparent over a selective wavelength range and being electrically conducting, the fabrication of the multilayer structure comprising forming a top oxide layer having an exposed top surface that provides an outer surface of the multilayer structure and an inner surface that is opposite to the exposed top surface; forming a bottom oxide layer having an exposed bottom surface that provides an outer surface of the multilayer structure, which is opposite to the exposed top surface, and an inner surface that is opposite to the exposed bottom surface; forming a first control layer provided on the inner surface of the top oxide layer; and forming a second control layer provided on the inner surface of the bottom oxide layer, the first and the second control layers calibrated to have the multilayer structure attenuate light over a first wavelength range and attenuate light over a second wavelength range, the light of the first wavelength range being different from the light of the second wavelength range.

### BRIEF DESCRIPTION OF THE DRAWINGS

Example embodiments of the invention will be better understood and readily apparent to one of ordinary skill in the art from the following written description, by way of example only, and in conjunction with the drawings. The drawings are not necessarily to scale, emphasis instead generally being placed upon illustrating the principles of the invention, in which:

FIG. 1 shows the structure of a multilayer structure according to a first embodiment.

FIG. 2 shows a plot of electrical resistance and carrier mobility both against the thickness of a first control layer of the multilayer structure shown in FIG. 1.

FIG. 3 shows the transmittance spectra of various multilayer structures.

FIG. 4 shows atomic force microscope (AFM) images of surface morphology of a multilayer structure and the multilayer structure of FIG. 1.

FIG. 5 shows a flowchart of a method to fabricate a multilayer structure shown in FIG. 1.

FIG. 6 shows a flowchart of a method in accordance with a second embodiment.

FIG. 7 shows cross-sectional views of compound structures having the multilayer structure of FIG. 1, including additional films.

FIG. 8 shows optical transparency of various structures.

FIG. 9 shows the transmittance and reflectance of various structures.

### DEFINITIONS

The following provides sample, but not exhaustive, definitions for expressions used throughout various embodiments disclosed herein.

The term “multilayer structure” may refer to a structure having one or more layers, of which one or more may be fabricated from semiconductor material.

The term “control layer” may mean a layer within the multilayer structure that is tuned to prevent light over a wavelength range from passing through, whereby the wavelength range is determined by the intrinsic properties of the material used for the control layer.

### DETAILED DESCRIPTION

In the following description, various embodiments are described with reference to the drawings, where like reference characters generally refer to the same parts throughout the different views.

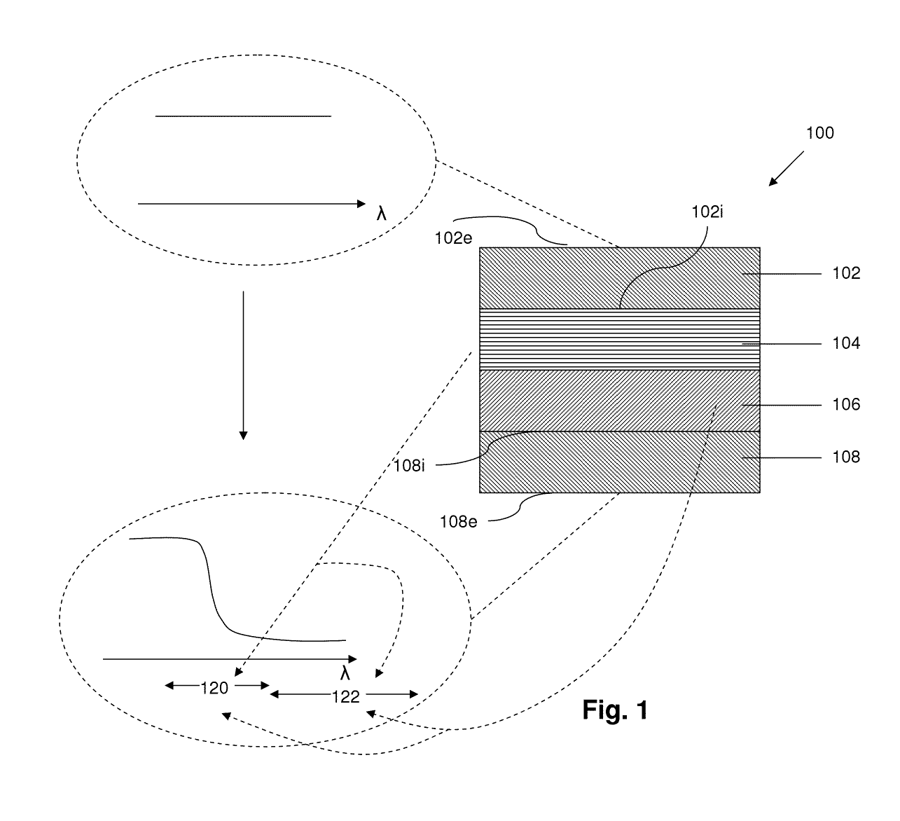

FIG. 1 shows the structure of a multilayer structure 100 according to a first embodiment.

The multilayer structure 100 has a plurality of layers (102, 104, 106 and 108), with each being optically transparent over a selective wavelength range and being electrically conducting. The plurality of layers (102, 104, 106 and 108) include: a top oxide layer 102, a bottom oxide layer 108, a first control layer 104 and a second control layer 106. The layers are arranged as follows.

The top oxide layer 102 has an exposed surface 102e that provides an outer surface of the multilayer structure 100 and an inner surface 102i that is opposite to the exposed surface 102e. The bottom oxide layer 108 has an exposed surface 108e that provides an outer surface of the multilayer structure 100, which is opposite to the exposed surface 102e provided by the top layer 102, and an inner surface 108i that is opposite to the exposed surface 108e.

The first control layer 104 is provided on the inner surface 102i of the top oxide layer 102. The second control layer 106 is provided on the inner surface 108i of the bottom oxide layer 108. The first and the second control layers 104 and 106 are calibrated to have the multilayer structure 100 attenuate light over a first wavelength range 120 and over a second wavelength range 122. The light of the first wavelength range 120 is different from the light of the second wavelength range 122. In one embodiment, the combination of the first control layer 104, the second control layer 106 and the respective adjacent oxide layer (i.e. either the top oxide layer 102 or the bottom oxide layer 108) are responsible for rejecting the light over the first wavelength range 120 and the light over the second wavelength range 122.

In one embodiment, the first control layer 104 and the second control layer 106 are fabricated from materials that allow for higher transmission of light over the visible range (400-700 nm) as compared to light over the NIR (700 nm-1400 nm) and SWIR (1.4 to 3 μm) ranges. Such materials include silver (Ag) for the first control layer 104 and germanium for the second control layer 106, where zinc oxide (ZnO) is used for both the top oxide layer 102 and the bottom oxide layer 108. Ag is able to reflect over 80% of light at a wavelength of 1 μm or more. As bulk Ge is opaque, an ultrathin Ge layer is used, which is transparent. Accordingly, embodiments of the invention find applications as a coating over windows, since the multilayer structure 100 reduces heat that passes through such coated windows.

As shown in the embodiment of FIG. 1, the facing surfaces of the first control layer 104 and the second control layer 106 are in contact. However, in another embodiment (not shown), the multilayer structure may further comprise one or more further control layers between the first control layer and the second control layer. The one or more further control layers may be fabricated from the same material as either the first control layer or the second control layer. In this other embodiment, the one or more further control layers are arranged in an alternating manner. For example, if Ag and Ge are used, the alternating arrangement may a repeating sequence of a Ag layer disposed adjacent to a Ge layer, i.e. Ag/Ge/Ag/Ge . . . Such an alternating arrangement may be used for applications where low transmission of visible light is desired.

The top oxide layer 102 and the bottom oxide layer 108 are doped, for instance using a Group III dopant. Doping enhances the electrical conductivity of the top oxide layer 102 and the bottom oxide layer 108. This ensures that the multilayer structure 100 is electrically conducting, thereby allowing the multilayer structure 100 to be used in photovoltaic and optoelectronic devices.

The top oxide layer 102 and the bottom oxide layer 108 may be made from the same material. However, in another embodiment, the top oxide layer 102 and the bottom oxide layer 108 may be made from different materials. Exemplary material that can be used for the top oxide layer 102 and the bottom oxide layer 108 include any one or more of the following: zinc oxide, zirconium oxide, titanium oxide, aluminum oxide and fluorinated tin oxide. The second control layer 106 may be fabricated from material comprising any one or more of the following metals: germanium, silicon, nickel and chromium. The first control layer 104 may be fabricated from material comprising any one or more of the following metals: silver, gold, aluminum, copper and platinum.

The materials used for the top oxide layer 102, the bottom oxide layer 108, the first control layer 104 and the second control layer 106 are all non-poisonous, thereby eliminating toxicity issues associated with using poisonous materials. It is highly advantageous to use materials that are non-toxic (as opposed to available multilayer structures that have indium based derivatives) as the transparent nature of the multilayer structure 100 provides widespread applications such as use in solar panels and use in windows for automobiles, building and disposable construction materials. In more details, in pursuing a greener environment, the multilayer structure 100, when used on windows of buildings, provides energy-savings as less energy is needed for the air-conditioning used to keep such buildings cool, while protecting the windows from heating effects. The multilayer structure 100 also can be used in consumer health care products and disposable electronics. With such widespread applications in devices that have close human interaction, it is thus advantageous that the multilayer structure 100 has a low environment toxicity impact. Thus, it is desirable for the multilayer structure 100 to use indium-free materials.

The top oxide layer 102 and the bottom oxide layer 108 each have thickness of less than 100 nm. The first control layer 104 may be about 0.1 to about 30 nm thick and the second control layer 106 may be about 0.1 to about 5 nm thick. Accordingly, it is possible for the multilayer structure 100 to have total thickness of less than 150 nm. Such a thickness provides savings in terms of material cost compared to the amount of material needed in commercial coatings of thickness around 1 to 2 mils (25400 to 50800 nm). However, the thickness of the multilayer structure 100 may be increased to be more than 150 nm for applications that require low visible light transmission, such as the rear window of an automobile.

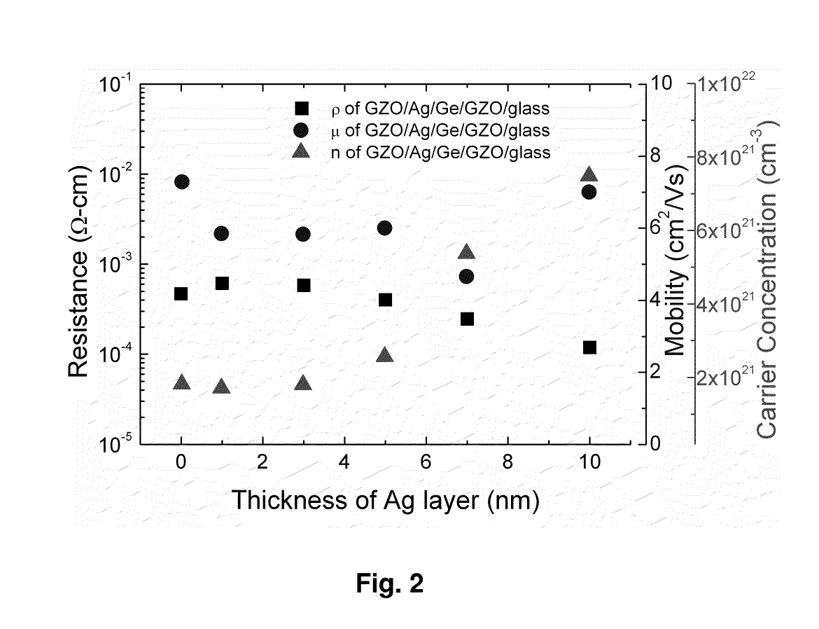

FIG. 2 shows a plot of electrical resistance and carrier mobility both against the thickness of the first control layer 104 of the multilayer structure 100 shown in FIG. 1. In FIG. 2, silver is used for the first control layer 104.

A commercially available structure (not shown) comprising a silver layer sandwiched between two indium tin oxide (ITO) layers can have electrical resistivity of around 2×10⁻⁴ Ω-cm. FIG. 2 shows that similar or even lower resistivity of around 1.2×10⁻⁴ Ω-cm is obtainable over a range of thicknesses of silver being used for the first control layer 104 in the multilayer structure 100. Accordingly, a multilayer structure according to a first embodiment is able to match or have even better conductivity as compared to the commercial available structure with a single ITO layer. A sample thicknesses of the multilayer structure according to the first embodiment is around 150 nm, being comparable to the 100 nm thickness of the commercially available structure with the single ITO layer. A further advantage lies in the fabrication procedure of these two multilayer structures. For a typical ITO layer to achieve electrical resistivity of around 2×10⁻⁴ Ω-cm, it has to be fabricated under heat treatment of more than 300° C. On the other, such heat treatment is not needed for the multilayer structure according to a first embodiment, as it is fabricated under room temperature, which will be described in further detail later.

In addition to low resistivity, it is essential for TCOs (transparent conducting oxides) to have high transparency, especially when they are used for photovoltaic, optoelectronic and window coating applications.

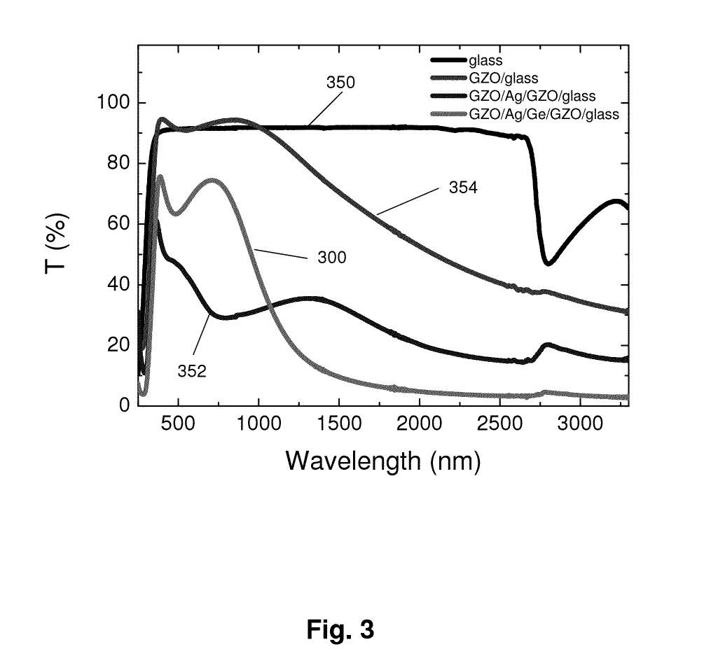

FIG. 3 shows the transmittance spectra of: glass; glass coated with a GZO film; glass coated with a GZO/Ag/GZO (i.e. a multilayer structure comprising a silver layer sandwiched between two oxide layers) film; and glass coated with a GZO/Ag/Ge/GZO (i.e. the multilayer structure 100 of FIG. 1, wherein silver and germanium are used for the first control layer 104 and the second control layer 106 respectively) film. ZO represents zinc oxide, while G indicates that the zinc oxide has been doped with a Group III dopant. The transmittance spectrum of glass is indicated using the reference numeral 350;

glass coated with the GZO film, 354; glass coated with the GZO/Ag/GZO film, 352; and glass coated with the GZO/Ag/Ge/GZO film, 300.

Pure glass (see the graph indicated by the reference numeral 350) has high transparency in the visible, NIR (near-infrared) and SWIR (short-wavelength infrared) ranges as shown in FIG. 3. The single layer TCO (i.e. the glass coated with GZO, graph indicated by the reference numeral 354) has high transparency in the visible range. While transparency for the single layer TCO starts to decrease gradually after the NIR range, this is still not desirable for window coating application as much of the infra red rays still pass through the film. Moreover, for the single layer TCO, there is no control over the transparency range.

Metal/TCO layered structures (see the graph indicated by the reference numeral 352) has improved IR rejection in the NIR and SWIR ranges. However, it suffers from low transparency in the visible range, compared to that of glass, which is also not desirable. Commercial branded films for automobile or building windows use many layers of coating to obtain their infrared reflection properties, this will lead to a reduction in transparency in the visible range leads to a loss of clarity. GZO/Ag/GZO do have high IR rejection but visible transmission is low. GZO/Ag/Ge/GZO multilayer structures 100 are able to provide high visible and low IR rejection in NIR and SWIR ranges.

The multilayer structure 100 of FIG. 1 (see the graph indicated by the reference numeral 300) has a reasonable high transparency in the visible region and an improved IR rejection in both NIR and SWIR range. This is highly advantageous for window coating applications. Using the multilayer structure 100, it is possible to obtain a higher transparency range over the visible to NIR wavelength, compared to the lower transparency range over the SWIR range. Comparing graphs 300 and 352, the glass coated with the GZO/Ag/Ge/GZO has average transmittance of >70% in the visible region, being better than the average transmittance of ˜50%, of the glass coated with the GZO/Ag/GZO film, which does not have a Ge layer.

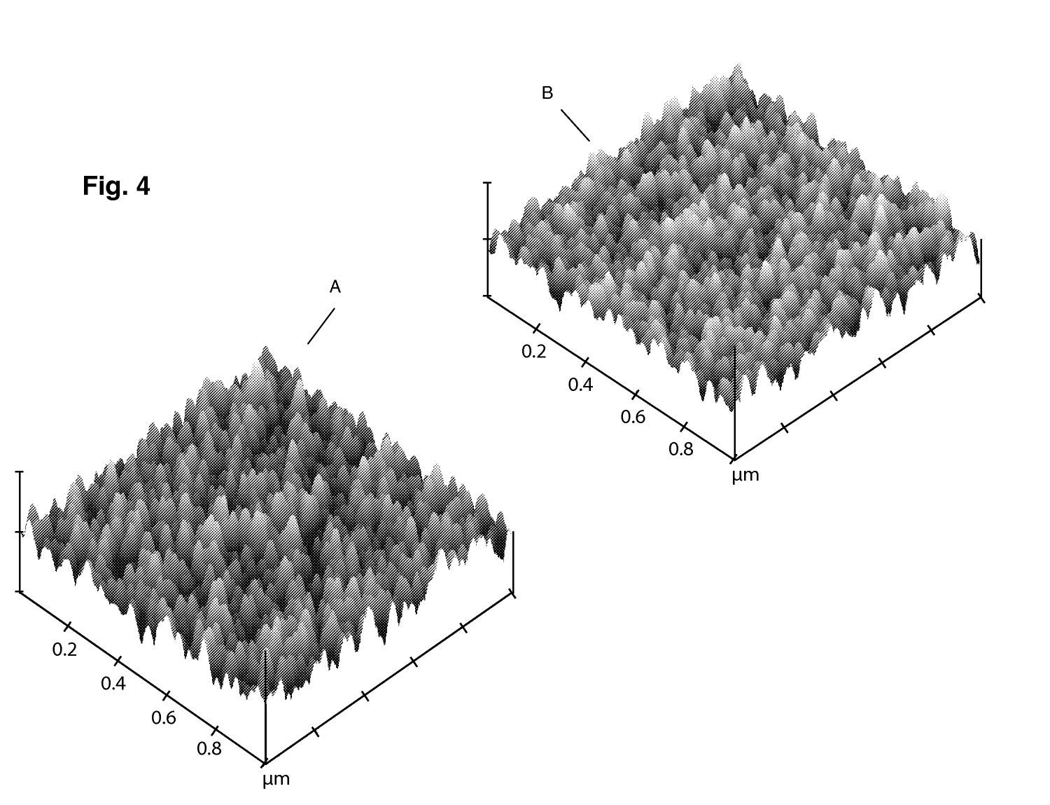

With reference to FIG. 1, when silver is used for the first control layer 104, using Ge for the second control layer 106 results in a buffer layer that lowers the root mean square roughness of the multilayer structure 100, for all silver thickness. FIG. 4 shows atomic force microscope (AFM) images of surface morphology of (A) GZO/Ag/GZO/glass and (B) GZO/Ag/Ge/GZO/glass. Comparing the two images, it can be seen that GZO/Ag/Ge/GZO/glass has better surface morphology. This better surface morphology can be shown to be a result of affecting deposition mean free path of adatoms on the glass substrate, thereby affecting nucleation sizes. The multilayer structure 100 thus addresses issues relating to control of surface roughness in multilayer structures having transparent conducting oxides being used as intermediate or bottom electrodes. A rough surface affects the properties of subsequent layers, as the roughness of every layer will depend on the flatness of the previous layer. Thus, the smoother surface presented by the multilayer structure 100 facilitates the multilayer structure 100 to be used as an intermediate or bottom electrode. The heat treatment used to fabricate films with a multilayer structure comprising ITO also produces the undesirable effect of roughening the film and therefore affecting the quality of the subsequent film coating or deposition.

Indium tin oxide or ITO is the primary component in available transparent films that reject IR. Indium tin oxide comprising of around 90% In₂O₃ and around 10% SnO₂ has been the primary transparent conductive oxide for display technology, photovoltaic and optoelectronic applications. Therefore, indium takes up a huge portion of the cost of raw materials used to fabricate ITO. However, the supply of indium has become inconsistent during the last 20 years. Frequent fluctuations and shortages have resulted in escalating indium prices thereby causing a strain in the manufacturing cost.

On the other hand, ZnO is abundant and inexpensive. Nearly 200 million tons were economically viable in 2008; adding marginally economic and sub-economic reserves to that number, a total reserve base of 500 million tons were identified, as mentioned in the 2009 document “Mineral Commodity Summaries 2009: Zinc, United States Geological Survey” by Tolcin, A. C. Therefore, embodiments of the multilayer structure 100 shown in FIG. 1 that use doped ZnO for both its top oxide layer 102 and its bottom oxide layer 108 use lower cost material as compared to ITO. With deposition of a few nm of silver and germanium for the first control layer 104 and the second control layer 106 respectively, selective transparency in the NIR wavelength is obtainable.

In addition to its abundance, zinc oxide is non-toxic. This is demonstrated by its usage as an ingredient in cosmetics, such as sunscreen products. Group III elements, such as Gallium (<5%) is also considered non-toxic, unlike indium compounds. The other materials used to fabricate the multilayer structure 100 are also non-toxic: silver (used for the first control layer 104) is used in jewelry, while germanium (used for the second control layer 106) is used in biomagnetic therapy such as bracelets.

From the above, the multilayer structure 100 is able to provide a transparent film having IR rejection in both NIR and SWIR ranges and yet is electrically conductive. Electrical conductivity of an electrode in a photovoltaic (PV) device is a critical parameter to determine the performance of the photovoltaic (PV) device. One approach is to use a thick highly conductive metal layer for its electrode. However, this reduces the transparency of such a film. The multilayer structure 100 provides good electrical conductivity (as explained with reference to FIG. 2) and yet does not require such a thick metal layer (it was earlier mentioned that the top oxide layer 102 and the bottom oxide layer 108 may each have thickness of less than 100 nm, while the first control layer 104 may be about 0.1 to about 30 nm thick and the second control layer 106 may be about 0.1 to about 5 nm thick).

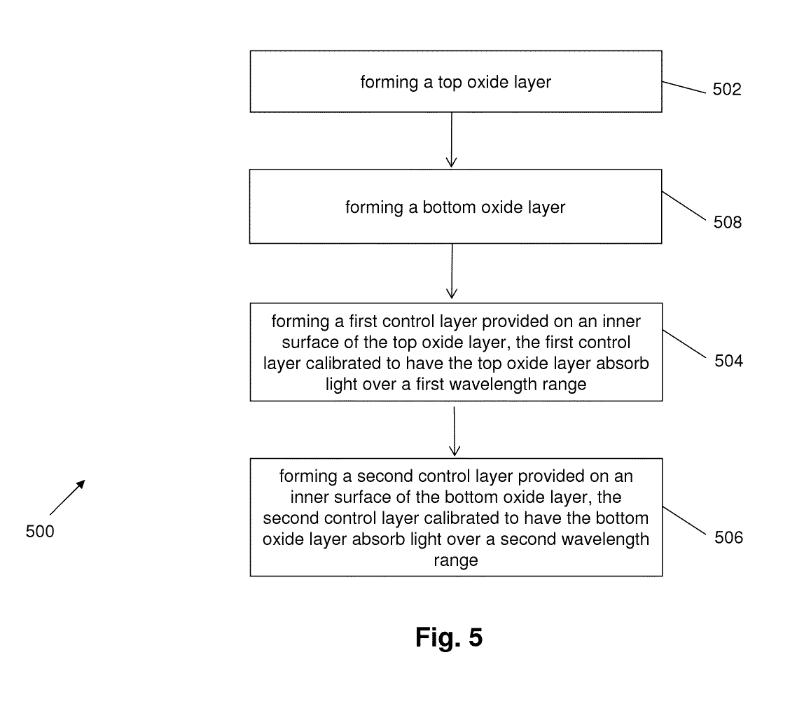

FIG. 5 shows a flowchart 500 of a method to fabricate a multilayer structure (APD) according to the first embodiment shown in FIG. 1. Accordingly, the multilayer structure will have a plurality of layers, with each being optically transparent over a selective wavelength range and being electrically conducting. The fabrication of the plurality of layers is as follows.

In step 502, a top oxide layer having an exposed surface that provides an outer surface of the multilayer structure and an inner surface that is opposite to the exposed surface is formed.

In step 508, a bottom oxide layer having an exposed surface that provides an outer surface of the multilayer structure is formed. The exposed surface of the bottom oxide layer is opposite to the exposed surface provided by the top layer. The bottom oxide layer has an inner surface that is opposite to its own exposed surface.

In step 504, a first control layer is formed, which is provided on the inner surface of the top oxide layer. The first control layer is calibrated to have the top oxide layer absorb light over a first wavelength range.

In step 506, a second control layer is formed, which is provided on the inner surface of the bottom oxide layer. The second control layer is calibrated to have the bottom oxide layer absorb light over a second wavelength range. The light of the first wavelength range is different from the light of the second wavelength range.

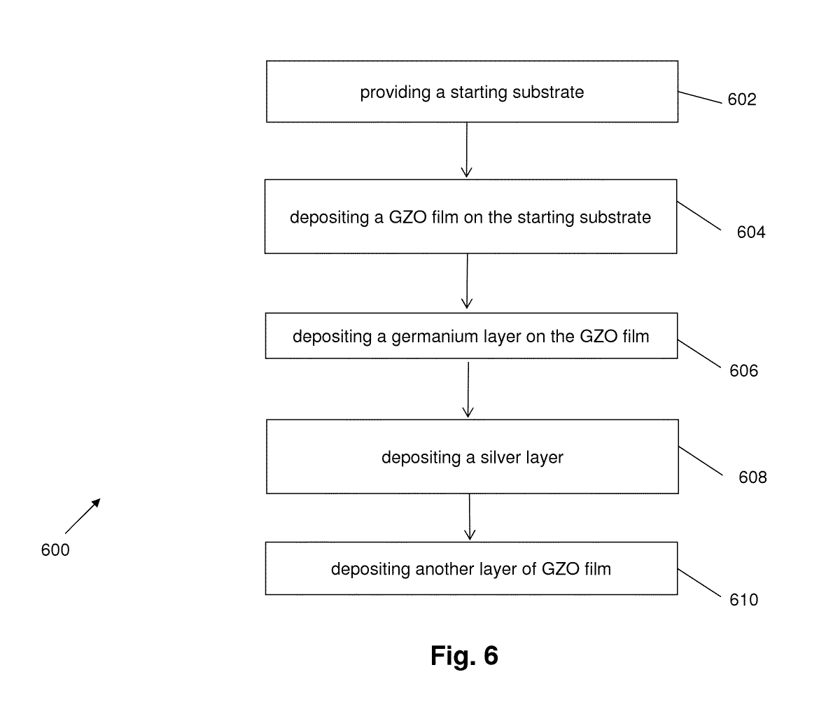

FIG. 6 shows a flowchart 600 of a method in accordance with a second embodiment of the invention. The flowchart 600 may begin in step 602 with fabricating a multilayer structure on a starting substrate, such as glass used for building or automobile windows; or semiconductor bulk silicon. In such a second embodiment, the method may comprise the following steps:

a) In step 602, the starting substrate is cleaned with acetone and ethanol before blowing dry with compressed air;

b) At step 604, depositing a Group III-doped ZnO (GZO) film at precise oxygen pressure at room temperature to form the bottom oxide layer;

c) At step 606, depositing a thin germanium layer for the second control layer, followed by a silver layer at step 608 for the first control layer in a pressure <1×10⁻⁶ Torr. The thicknesses of the germanium and silver layers are calibrated carefully to be respectively about 0.1 to about 5 nm and about 0.1 to about 30 nm or each around 0.1 to about 20 nm. Ag and Ge are metals which are prone to oxidise quickly under normal ambient conditions. Therefore, the deposition of both Ge and Ag layers may occur inside a vacuum chamber, so that oxidation does not occur that results in an additional undesired layer formed between Ge and Ag during their respective deposition;

d) At step 610, depositing another layer of Group III-doped ZnO film for the top oxide layer at precise oxygen pressure of 1×10⁻⁴ to 5×10⁻⁴Torr at room temperature.

The Group III-doped ZnO films for the top oxide layer and the bottom oxide layer are only deposited after oxygen pressure has stabilised. The deposition rate in steps b) to d) may be controlled to ensure good quality film growth.

The process used in the fabrication of the second embodiment may also be similarly used in the first embodiment. Accordingly, the top oxide layer and/or the bottom oxide layer may be formed at room temperature. The remaining layers of the multilayer structure (the first control layer and the second control layer) may similarly be fabricated at room temperature.

Thus, the multilayer structure may be directly fabricated on heat-sensitive substrates or substrates with heat sensitive layers, such as organic devices and any devices that use materials with low melting points. Modification of the already deposited film structures on such temperature sensitive devices is not required. Thus, the process shown in FIG. 5 provides a reliable way to fabricate multilayer structures that are both transparent and electrically conductive. On the other hand, it is not suitable to fabricate available films that have ITO layers on electronic devices that cannot withstand temperature, since an improvement in both the electrical conductivity and transparency of ITO only acquired after a heat treatment of >300° C. The multilayer structure of the first and second embodiments obtain better electrical and optical properties compared to films using ITO layers (see FIG. 2 above), without need for heat treatment.

Similar to the second embodiment, the first control layer and the second control layer of the first embodiment may be formed under pressure in the range of around 1×10⁻⁶ Torr. A selection of the plurality of layers (such as the top oxide layer and the bottom oxide layer) of the multilayer structure may also be formed in the presence of oxygen.

The plurality of layers may be formed by vapour deposition. Physical vapour deposition is a technique that can uniformly cover large areas of at least 200 mm (8 inch) diameter wafers. Physical vapour deposition is widely used in semiconductor and disk drive manufacture. Therefore, the setup cost to fabricate the multilayer structure according to the first or second embodiment is low.

Similar to the second embodiment, the top oxide layer and the bottom oxide layer of the first embodiment may be formed from the same material. The top oxide layer and the bottom oxide layer may also be doped. Exemplary material for both the top oxide layer and the bottom oxide layer include Group III doped zinc oxide, where these transparent oxides may each be grown to a thickness of less than 100 nm.

Alternative materials to replace ITO in available multilayer structures include carbon nanotube, graphene, metal nanowires and fluorinated tin oxide. However, several of these alternatives suffer from a reciprocal relationship between having high transparency and low conductivity. Some of them require development of non-mature manufacturing methods and equipments for large scale production. On the other hand, Group III doped zinc oxide does not suffer from these limitations.

Similar to the second embodiment, germanium may be used for the second control layer, while silver for the first control layer of the first embodiment. These metallic films of germanium and silver, which are used to calibrate the electrical conductivity of the multilayer structure and its rejected light wavelength ranges, each have thickness of around 0.1 to 20 nm and are therefore thinner compared to the top and bottom oxide layers. Compared to available coatings of thickness of at least 1 mil (25400 nm), the multilayer structure of the first and the second embodiments use less raw materials and are thus cheaper to manufacture.

It has been found to be difficult to fabricate thin films, using materials such as zinc oxide, germanium and silver, at room temperature and have such films achieve good electrical conductivity and transparency. However, as mentioned above, the multilayer structure according to the first embodiment and the second embodiment has good electrical conductivity and is optically transparent over a selective wavelength range, and is fabricated under room temperature. This room temperature fabrication is performed by controlling both oxygen pressure and the growth rate to achieve desired results.

Oxygen pressure is controlled by the amount of oxygen flow, the pumping speed of a turbo pump and a valve regulator. By controlling these three factors, the quality of the film can be optimised. The growth rate of the film at a specified pressure is calibrated by depositing the same film at different deposition times. The thickness of each grown film is then measured using atomic force microscopy to obtain a growth rate relationship of film thickness with respect to time. Alternatively, the thickness of each grown film can also be measured by monitoring quartz crystal thickness during growth. Once the growth rate is determined, the thickness of the film can be adjusted by deposition time. The performance of the multilayer structure according to the first and second embodiments are found to be comparable or better than available films that use ITO, which are fabricated at temperatures above 300° C.

The multilayer structure, according to the first and second embodiments, consists of 4 layers and is fabricated from three different materials. Compared to commercial brands which use many different layers to exhibit the IR rejection effect, it is simpler to fabricate the multilayer structure, according to the first and second embodiments.

The adding of a thin layer of Ge as the second control layer, prior to Ag as the first control layer enhances the conductivity of the multilayer structure, as compared to a multilayer structure without such a Ge layer. Moreover, this Ge layer does not cause a significant decrease in the transparency of light in the 400 to 700 nm wavelength range and is able to boost the IR rejection in the NIR and SWIR range. Collectively, the first control layer and the second control layer together allow for the absorption of light in a first wavelength range of about 700 nm to about 1400 nm and a second wavelength range of about 1400 nm to about 3000 nm.

About 65% of a typical building electrical bill may be due to lighting and cooling costs. With rising cost of cement and steel, coated glass that allows natural lighting (as opposed to electrical lighting) and has high IR rejection property is advantageous. The multilayer structure, according to the first and second embodiments, can control the heat reflecting property of windows while maintaining a high visible transparency due to the additional Ge layer. Accordingly, such a multilayer structure can be used to coat windows in buildings and automobiles which can greatly reduce exterior heat from entering the air-conditioned interior. This keeps the interior of the buildings and automobiles cool and decreases the high dependency on air-conditioners to keep the interior cool, hence reducing electricity used.

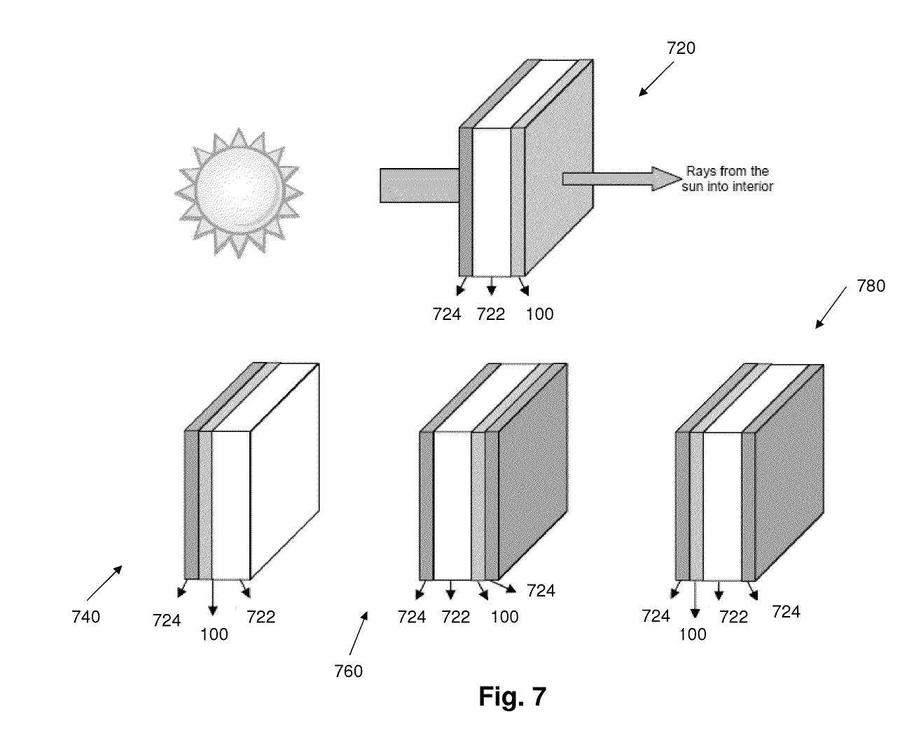

Further applications may have the multilayer structure 100 of FIG. 1 used in conjunction with one or more additional films that can filter light over a wavelength range that is different from the wavelength ranges already filtered by the multilayer structure 100. In such further applications, the resulting structure may have infrared (IR) reflective and self-cleaning properties, while being able to filter light over an ultra-violet (UV) wavelength. FIG. 7 shows cross-sectional views of compound structures 720, 740, 760 and 780 illustrating different physical arrangements of such additional films relative to the multilayer structure 100 of FIG. 1.

The compound structures 720, 740, 760 and 780 comprise a substrate 722 with the multilayer structure 100 being provided on a surface of the substrate 722. In one embodiment, it is the exposed top surface (which is hidden from view) of the multilayer structure 100 that is in contact with the surface of the substrate 722. The substrate 722 is further provided with at least one oxide film 724 calibrated to attenuate light over a third wavelength range, the light of the third wavelength range being different from the light of the first and the second wavelength ranges that are attenuated by the multilayer structure 100. This third wavelength range may be, in a preferred embodiment, a UV wavelength band.

For the compound structure 720, the oxide film 724 is in contact with an opposite surface of the substrate 722, i.e. on the surface of the substrate 722 opposite to the one having thereon the multilayer structure 100.

For the compound structure 740, the multilayer structure 100 is disposed between the oxide film 724 and the substrate 722. If the exposed top surface (which is hidden from view) of the multilayer structure 100 is in contact with the substrate 722, then it will be the exposed bottom surface (which is also hidden from view) of the multilayer structure 100 that is in contact with the oxide film 724. Thus, the structure 740 is arranged to have the oxide film 724 and the multilayer structure 100 disposed on a same side of the substrate 722. The surface opposite to the one where the multilayer structure 100 and the oxide film 724 are disposed is exposed.

For the compound structure 760, a first oxide film 724 is in contact with an opposite surface of the substrate, i.e. on the surface of the substrate 722 opposite to the one having thereon the multilayer structure 100. The multilayer structure 100 is disposed between a second oxide film 724 and the substrate 722. If the exposed top surface (which is hidden from view) of the multilayer structure 100 is in contact with the substrate 722, then it will be the exposed bottom surface (which is also hidden from view) of the multilayer structure 100 that is in contact with the second oxide film 724. The compound structure 780 is simply a mirror image of the compound structure 760.

In one embodiment of the invention, the multilayer structure 100 may comprise a Group III doped zinc oxide/metal/Group III-doped zinc oxide structure deposited on glass or polymeric substrate by physical vapor deposition. In another embodiment, the multilayer structure 100 may comprise a Group III doped zinc oxide/Ag/Ge/Group III-doped zinc oxide structure deposited on glass or polymeric substrate by physical vapor deposition. For both embodiments, one or more layer(s) of titanium dioxide (TiO₂) are then deposited for the at least one oxide film 724. An exemplary fabrication method deposits titanium dioxide thin film layers onto the multilayer structure 100 at room temperature, under controlled deposition conditions to ensure good quality film growth.

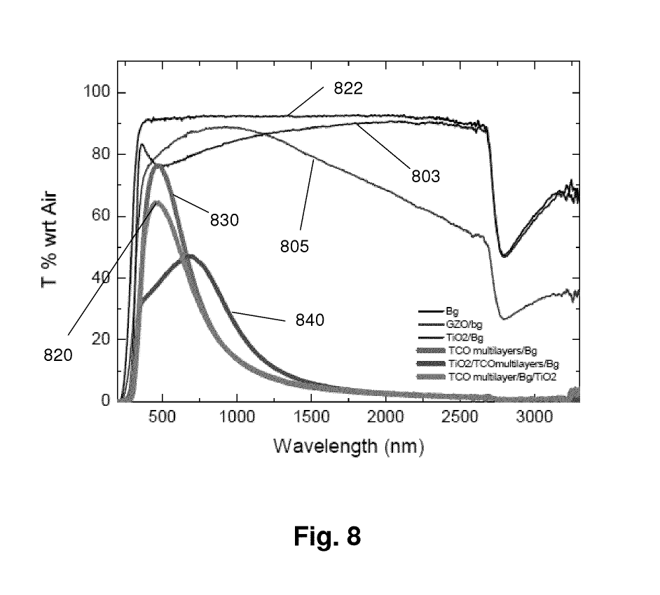

FIG. 8 shows optical transparency of: glass substrate (the curve labeled 822); glass substrate with a single layer of GZO (the curve labeled 805); glass substrate with a single layer of titanium oxide (the curve labeled 803); glass substrate with the multilayer structure 100 of FIG. 1 (the curve labeled 830); the compound structure 720 of FIG. 7 (the curve labeled 820); and the compound structure 740 of FIG. 7 (the curve labeled 840).

For the glass substrate with the multilayer structure 100, it can be observed from the curve 830 that there is high transparency over the light wavelength range to which the multilayer structure 100 allows to transmit without attenuation. The curve 830 also shows that there is low transmittance in the short wavelength infrared (SWIR) range. The main function of the glass substrate with the multilayer structure 100 is to provide IR reflection.

For the compound structures 720 and 740 (which have additional titanium dioxide thin films, compared to the glass substrate with the multilayer structure 100), these compound structures 720 and 740 can have self-cleaning and UV filtering properties, while inheriting the scratch resistant property that a TiO₂ film provides. These additional advantages are achieved with only a slight decrease in transmission of light over the visible wavelength range. The advantageous property of low transmission in the SWIR is still preserved. For the compound structure 740, a visible light transmission of over 65% is obtained and it has a U-value of 2.46 W/(m²K). The G-value measured from this sample is 0.25 with a shading coefficient of 0.28.

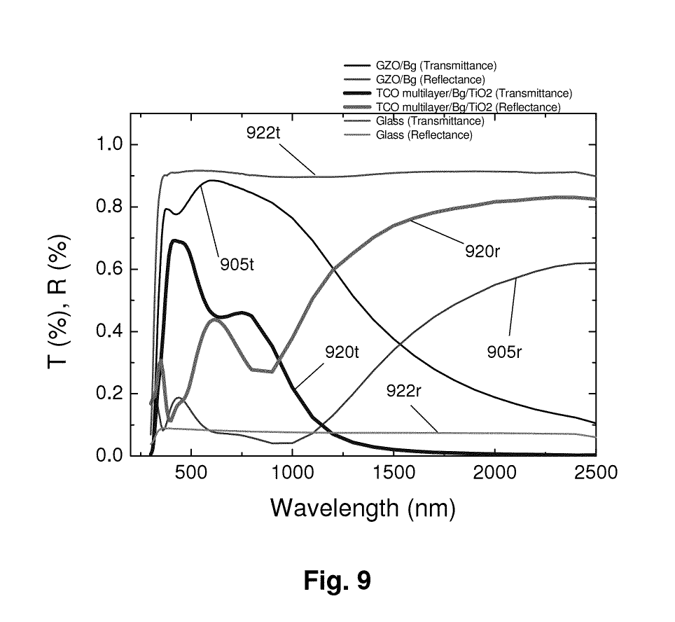

FIG. 9 shows the transmittance and reflectance of: glass (the curves labeled 922t and 922r respectively); glass substrate with a single layer of GZO (the curves labeled 905t and 905r respectively); and the compound structure 720 of FIG. 7 (the curves labeled 920t and 920r respectively).

From the curves 922t and 922r, it can be observed that bare glass has a very high transmittance and very low reflectance. This means that when using bare glass as window panel, the interior of a room/automobile will get warm after some time without air-conditioner.

From the curves 905t and 905r, glass substrate with a single layer of GZO has high transmittance over light in the visible region, but not very high reflectance in the SWIR range.

From the curves 920t and 920r, the compound structure 720 of FIG. 7 has high transmittance in the visible range, meaning the sample is transparent. The reflectance in SWIR range is high and at 1400-2500 nm wavelength range, the reflectance is over 70% and up to 80%, meaning much of the heat generating radiation is reflected, leading to a cooler interior. In addition, the TiO₂ layer provides the compound structure 720 with the self-cleaning, UV filtering and scratch resistant properties inherent to TiO₂.

The compound structures 720, 740, 760 and 780 of FIG. 7 have several features as listed below.

When using TiO₂ film for the oxide film 724, UV radiation from sunlight can be harvested to facilitate the self-cleaning property through photocatalysis. With this self-cleaning property, the frequency to clean the exterior façade of a building can be reduced. This self-cleaning is an additional advantage to the high transparency under visible light and low SWIR transmittance provided by the multilayer structure 100 of the compound structures 720, 740, 760 and 780.

The UV filtering provided by the TiO₂ film also prevents damage to organic materials. Organic materials like plastics, polymers and wood will experience a rapid photolytic and photo-oxidative reaction when exposed to UV radiation, which will result in their photo-degradation. Thus, the compound structure 720 of FIG. 7 finds applications for protecting such organic materials from photo-degradation. In addition, the TiO₂ film and all other layers of the multilayer structure 100 are non-toxic transparent substances.

Some films have difficulty to retain good adhesion on particular substrates, thus peeling may occur. However, a tape test performed on the compound structures 720, 740, 760 and 780 has the films provided on the substrate 722 remaining intact. The scratch resistant 724 layer also protects the multilayer structure 100 from been scratched easily and provides the compound structures 720, 740, 760 and 780 with a smooth surface.

The compound structures 720, 740, 760 and 780 inherit the advantages provided by a TiO₂ film, without a significant impact on the advantages brought about by the multilayer structure 100, being the transparency over visible light wavelength and IR rejection. With good transparency in the visible range, natural light from the exterior can enter and reduce the need of more lights in the day time as compared to a highly tinted glass. This is highly desirable for automobile and building facade applications.

The compound structures 720, 740, 760 and 780 utilise UV radiation in sunlight to initiate photocatalysis and perform self-cleaning. Simultaneously, the multilayer structure 100 rejects SWIR heat from the compound structures 720, 740, 760 and 780 being exposed to sunlight. This means that in addition to a self-cleaning process that occurs at the exterior of a building, the interior of the building is kept cool. This greatly reduces the need of additional air-con to keep the interior cool and indirectly reduces the electricity bill.

The TiO₂ film and the multilayer structure 100 can be deposited on glass at room temperature. This means there is no need to heat up any substrate. Less time is needed during the deposition process as there is no need to ramp up or ramp down or hold the temperature during growth. This also means that the TiO₂ film and the multilayer structure 100 can be deposit even onto flexible plastic. Physical vapor deposition may be used to deposit the TiO₂ film and the multilayer structure 100 onto the substrate. This represents excellent conformity with existing commercial technology that can yield high uniformity and high-throughput, providing a low barrier for utilisation. The additional TiO₂ films may each have thickness of less than 100 nm. This saves material cost as compared to the amount of raw materials needed for commercial coating of at least 1 mil (25400 nm). Thin films also mean that they are lightweight.

Each of the compound structures 720, 740, 760 and 780 may have 6 or more layers to achieve their desirable improvement in optical properties. All these layers are fabricated based on physical vapor deposition technique using only four different materials.

It will be appreciated by a person skilled in the art that numerous variations and/or modifications may be made to the present invention as shown in the embodiments without departing from a spirit or scope of the invention as broadly described. The elements of the various embodiments may be incorporated into each of the other species to obtain the benefits of those elements in combination with such other species, and the various beneficial features may be employed in embodiments alone or in combination with each other. The embodiments are, therefore, to be considered in all respects to be illustrative and not restrictive.

1. A multilayer structure having a plurality of layers, with each layer being optically transparent over a selective wavelength range and being electrically conducting, the multilayer structure comprising
a top oxide layer having an exposed top surface that provides an outer surface of the multilayer structure and an inner surface that is opposite to the exposed top surface;
a bottom oxide layer having an exposed bottom surface that provides an outer surface of the multilayer structure, which is opposite to the exposed top surface, and an inner surface that is opposite to the exposed bottom surface;
a first control layer provided on the inner surface of the top oxide layer; and
a second control layer provided on the inner surface of the bottom oxide layer, the first and the second control layers calibrated to have the multilayer structure attenuate light over a first wavelength range and over a second wavelength range, the light of the first wavelength range being different from the light of the second wavelength range.

2. The multilayer structure of claim 1, wherein the facing surfaces of the first control layer and the second control layer are in contact.

3. The multilayer structure of claim 1, further comprising one or more further control layers between the first control layer and the second control layer, the one or more further control layers being fabricated from the same material as either the first control layer or the second control layer.

4. The multilayer structure of claim 1, wherein the top oxide layer and the bottom oxide layer are made from the same material.

5. The multilayer structure of claim 4, wherein the material for the top oxide layer and the bottom oxide layer comprises any one or more of the following: zinc oxide, zirconium oxide, titanium oxide, aluminum oxide and fluorinated tin oxide.

6. The multilayer structure of claim 1, wherein the top oxide layer and the bottom oxide layer are doped with a Group III dopant.

7. The multilayer structure of claim 1, wherein the first control layer comprises any one or more of the following metals: silver, gold, aluminum, copper and platinum and wherein the second control layer comprises any one or more of the following metals: germanium, silicon, nickel and chromium.

8. The multilayer structure of claim 1 wherein the first control layer is about 0.1 to about 30 nm thick, the second control layer is about 0.1 to about 5 nm thick and the thickness of the multilayer structure is less than 150 nm.

9. A compound structure comprising
a substrate;
a multilayer structure provided on a surface of the substrate, the multilayer structure having a plurality of layers, with each layer being optically transparent over a selective wavelength range and being electrically conducting, the multilayer structure comprising:
a top oxide layer having an exposed top surface that provides an outer surface of the multilayer structure and an inner surface that is opposite to the exposed top surface;
a bottom oxide layer having an exposed bottom surface that provides an outer surface of the multilayer structure, which is opposite to the exposed top surface, and an inner surface that is opposite to the exposed bottom surface;
a first control layer provided on the inner surface of the top oxide layer; and
a second control layer provided on the inner surface of the bottom oxide layer, the first and the second control layers calibrated to have the multilayer structure attenuate light over a first wavelength range and attenuate light over a second wavelength range, the light of the first wavelength range being different from the light of the second wavelength range; and
at least one oxide film calibrated to attenuate light over a third wavelength range, the light of the third wavelength range being different from the light of the first and the second wavelength ranges.

10. The compound structure of claim 9, wherein the oxide film is in contact with an opposite surface of the substrate.

11. The compound structure of claim 9, wherein the multilayer structure is disposed between the oxide film and the substrate.

12. The compound structure of claim 9, wherein a first of the at least one oxide film is in contact with an opposite surface of the substrate and wherein the multilayer structure is disposed between a second of the at least one oxide film and the substrate.

13. A method of forming a multilayer structure having a plurality of layers, with each being optically transparent over a selective wavelength range and being electrically conducting, the fabrication of the multilayer structure comprising
forming a top oxide layer having an exposed top surface that provides an outer surface of the multilayer structure and an inner surface that is opposite to the exposed top surface;
forming a bottom oxide layer having an exposed bottom surface that provides an outer surface of the multilayer structure, which is opposite to the exposed top surface, and an inner surface that is opposite to the exposed bottom surface;
forming a first control layer provided on the inner surface of the top oxide layer; and
forming a second control layer provided on the inner surface of the bottom oxide layer, the first and the second control layers calibrated to have the multilayer structure attenuate light over a first wavelength range and attenuate light over a second wavelength range, the light of the first wavelength range being different from the light of the second wavelength range.

14. The method of claim 13, wherein the top and bottom oxide layers are formed at room temperature.

15. The method of claim 13, wherein the first control layer and the second control layer are formed under pressure in the range of around 1×10⁻⁶ Torr.

16. The method of claim 15, wherein the top and bottom oxide layers are formed in the presence of oxygen.

17. The method of claim 13, wherein the plurality of layers are formed by vapour deposition.

18. The method of claim 13, wherein the top oxide layer and the bottom oxide layer are formed from the same material.

19. The method of claim 13, further comprising doping the top oxide layer and the bottom oxide layer.

20. The multilayer structure of claim 1, wherein the first wavelength range is from about 700 nm to about 1400 nm and the second wavelength range is from about 1400 nm to about 3000 nm.
